(19) United States
(12) Patent Application Publication
(10) Pub. No.: US 2003/0042837 A1
(43) Pub. Date: Mar. 6, 2003

(54) Pre-focus lens in a HE-CRT

(76) Inventors: Willibrordus Adrianus Johannes Antonius Van Der Poel, Eindhoven (NL); Nijs Cornelis Van Der Vaart, Eindhoven (NL)

Correspondence Address: U.S. Philips Corporation, 580 White Plains Road, Tarrytown, NY, 10591, US

(21) Appl. No.: 10/227,209

(22) Filed: Aug. 23, 2002

(30) Foreign Application Priority Data
Aug. 28, 2001 (EP) 01203250.4

(51) Int. Cl. H01J 29/46; H01J 29/50

(52) U.S. Cl. 313/414; 313/449

(57) ABSTRACT

The invention relates to a cathode ray tube (100) comprising an electron source (101) having a cathode (105, 106, 107) for emitting electrons, an electron beam guidance cavity (120, 121, 122) having an input and an output aperture for concentrating electrons emitted from the cathode, a first electrode being connectable to a first power supply means for applying, in operation, an electric field having a first field strength E1 between the cathode (105, 106, 107) and the output aperture so as to allow electron transport through said electron beam guidance cavity (120, 121, 122), an accelerating grid (140) unit for accelerating the electrons leaving said cavity, and a main electron lens (150) for focusing the accelerated electrons on a display screen (170). According to the invention, said accelerating grid unit (140) further comprises a plurality of grids (G3, G4, G5) together constituting a pre-focus lens.

The present invention relates to a cathode ray tube comprising an electron source having a cathode for emitting electrons, an electron beam guidance cavity having an input and an output aperture for concentrating electrons emitted from the cathode, a first electrode being connectable to a first power supply means for applying, in operation, an electric field having a first field strength E1 between the cathode and the output aperture so as to allow electron transport through said electron beam guidance cavity, an accelerating grid unit for accelerating the electrons leaving said cavity, and a main electron lens for focusing the accelerated electrons on a display screen.

An embodiment of such a cathode ray tube is known from U.S. Pat. No. 5,270,611. This document describes a cathode ray tube provided with a cathode, an electron beam guidance cavity and a first electrode being connectable to a first voltage source for applying an electric field with a first field strength E1 between the cathode and the output aperture. The cavity wall comprises a material with a secondary emission coefficient δ.

The electron transport within the cavity is possible when a sufficiently strong electric field E1 is applied in a longitudinal direction of the electron beam guidance cavity. The value of this field depends on the type of material and more specifically on the secondary emission coefficient δ thereof, and on the geometry and sizes of the walls of the cavity.

The electron transport then takes place via a secondary emission process so that, for each electron impinging on a cavity wall, one electron is emitted on average. The circumstances can be chosen to be such that as many electrons enter the input aperture of the electron beam guidance cavity as will leave the output aperture.

When the output aperture is much smaller than the input aperture, an electron compressor is formed which concentrates the luminosity of the electron source by a factor of, for example, 100 to 1000. Such a cathode ray tube, sometimes referred to as a hopping electron cathode ray tube or a HE-CRT, may be used in television display devices, computer monitors and projection television sets.

The output aperture of the cavity is imaged on the display screen by an electron optical system as generally known from conventional CRTs. The electron optical system comprises the accelerating grid unit and the main lens.

In these types of cathode ray tubes, the exiting ray has such that an energy spread that an extra pre-focus lens must be introduced into the system in order to obtain optimal main lens filling for realizing a small beam spot on the display screen. One way of achieving this is by using a cup lens or by applying planar optics. Both these solutions are described in patent application WO-01/26131.

The solutions given in this patent application have the drawback that a reduced electric field occurs at the screen-side of the cavity, near the output aperture. This results in a relatively strong space charge, which forms a barrier for electrons exiting from the cavity. As a result, the exiting electrons have a relatively low energy and, consequently, the spot size, which is the size of the image of the output aperture on the display screen, is deteriorated.

It is therefore an object of the invention to provide a hopping electron cathode ray tube having a larger pulling field at the screen-side of the cavity, near the output aperture.

A first aspect of the invention provides a cathode ray tube as defined in claim 1. Advantageous embodiments are defined in the dependent claims.

The cathode ray tube is characterized in that said accelerating grid unit comprises a plurality of grids together constituting a pre-focus lens. By forming the pre-focus lens in the accelerating grid unit, the solutions from WO-01/26131 may be excluded from the cathode ray tube. Thus, a relatively high pulling field is achieved at the screen-side of the cavity near the output aperture. Consequently, space charge effects, resulting in an increased spot size, are reduced.

Furthermore, the present cathode ray tube is less sensitive to alignment errors than the known solutions. The cup lens or planar optics needs to be well aligned with the output aperture, whereas this requirement is more relaxed in the present cathode ray tube.

Moreover, by providing a pre-focus lens in the accelerating grid unit, an adjustable pre-focus may be obtained. This allows time-dependent or multimedia applications of the display.

In a preferred embodiment of the invention, said pre-focus lens is a low-uni-bi lens.

Preferably, said low-uni-bi lens comprises a first, a second and a third grid G3, G4 and G5, respectively, said first grid G3 being an accelerating grid, wherein said first and third grids G3 and G5 are connectable to a third power supply providing a voltage V_{g3} and said second grid G4, being placed between said first and third grids, is connectable to one of the potentials of said first electrode or a separate voltage Vₛ. Here, the voltage V_{g3} is preferably within the range of 0.15 Vₐ-0.35 Vₐ, Va being the voltage of an anode in said cathode ray tube. Furthermore, the voltage Vₛ may be suitably within the range of 0-V_{g3} or may be connected internally to a first voltage source, to the output aperture. Furthermore, said first electrode is suitably positioned in close proximity with said output aperture of the cavity.

In accordance with an alternative embodiment of the invention, the first electrode comprises a first and a second part being placed behind each other along an axis of said main electron lens, wherein a diameter of said first part is smaller than a corresponding diameter of said second part. A so-called cup lens is thus generated, resulting in an additional pre-focusing of the beam.

If only a cup lens were present, the relatively low field near the output aperture would cause chromatic lens errors. By applying this embodiment comprising both a cup lens and a pre-focus lens in the accelerating grid unit, the pulling field is increased and chromatic lens errors are reduced. Furthermore, the electron beam exits from a cup lens with a fixed diameter, whereas this embodiment permits modulation of the beam diameter, which may be valuable in certain applications.

In accordance with yet another embodiment of the invention, the cathode ray tube further comprises a second electrode being concentric with said first electrode, said second electrode being connectable to a second power supply means for applying a second field strength E2 between said electrodes, wherein the second power supply means is arranged to provide a lower voltage than the first power supply means. Thus, a planar electron lens having a pre-focusing ability for the electron beam is created, the so-called planar optics.

One advantage of this planar optics is that some electron lens characteristics are adjustable after the cathode has been mounted in a cathode ray tube. This construction may be used in operation to modulate the aperture angle of the electron beam.

Combining the planar optics with a pre-focus lens in the accelerating grid unit has the advantage that the electron beam is at least partially pre-focused by the accelerating grid unit, so that the voltage difference between the planar optics electrodes may be reduced. This decreases the risk of flash-over between the planar optics electrodes.

The planar optics electrodes may be suitably positioned in essentially one plane.

These and other aspects of the present invention will now be described in closer detail, with reference to the accompanying drawings. In all drawings, corresponding parts are denoted by corresponding reference numerals, starting with a numeral denoting the number of the drawing. A full description of each component for each FIG. is therefore excluded in some cases. In the drawings:

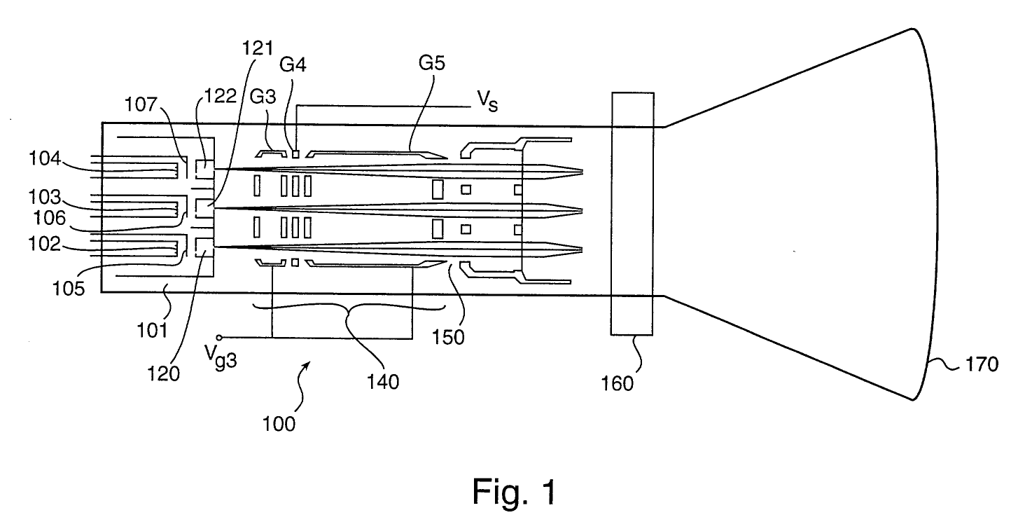

FIG. 1 is a schematic drawing of a hopping electron cathode ray tube, having a low-uni-bi pre-focusing lens according to the invention;

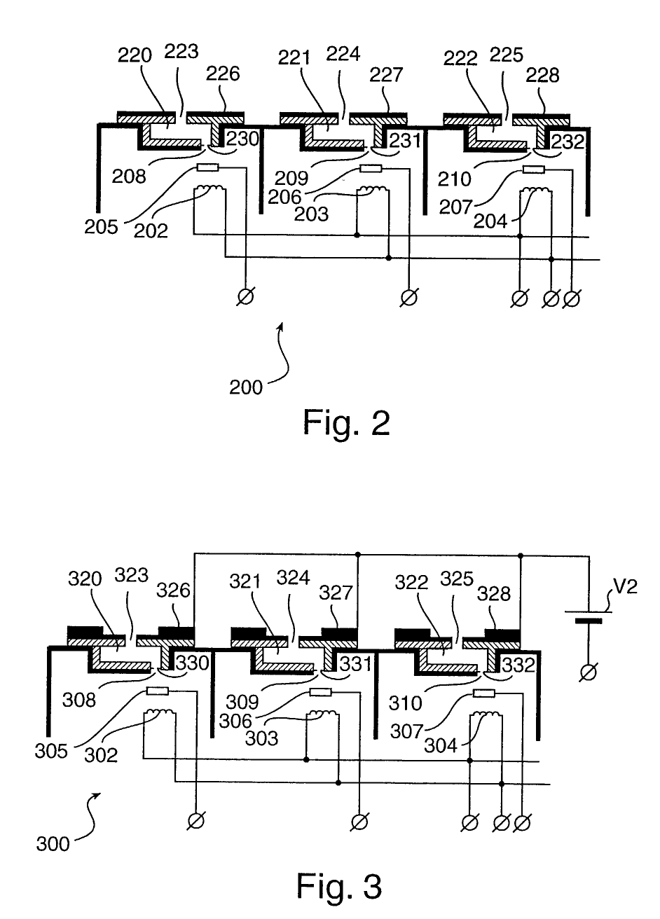

FIG. 2 is a schematic cross-section of a cathode structure for use with the invention;

FIG. 3 shows a second embodiment of a cathode structure for use with the invention, utilizing a cup lens, and

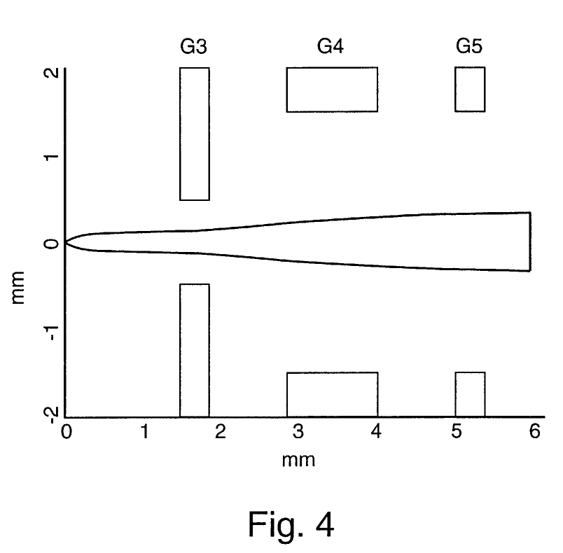

FIG. 4 is a schematic cross-section of a part of a cathode ray tube according to the invention, showing the electron beam path through a low-uni-bi pre-focusing lens.

FIG. 1 is a schematic diagram of a cathode ray tube 100 according to the invention. The cathode ray tube 100 comprises an electrode structure 101, having cathodes 105, 106, 107 for emitting electrons and electron beam guidance cavities 120, 121, 122 for guiding the emitted electrons to a beam guidance cavity output aperture, through which the emitted electrons are arranged to exit. The embodiment of the cathodes and the cavities are known per se from e.g. WO 00/79558, and also comprises heating filaments 102, 103, 104.

The interior of said electron beam guidance cavities, around said output apertures, is at least partly covered by an insulating material having a secondary emission coefficient δ, where δ>1.

The cathodes 105, 106, 107 and the electron beam guidance cavities 120, 121, 122 are preferably arranged in triplicate, as shown in FIG. 1, so that the cathode ray tube 100 may be used to display color images, but the invention is also applicable to other configurations, such as a monochrome one-beam display having a single cathode (not shown).

An electrode structure 200 for the cathode ray tube is shown in more detail in FIG. 2. The cathode ray tube comprises first electrodes 226, 227, 228, which are arranged around each output aperture 223, 224, 225, on the outer side of each electron beam guidance cavity 220, 221, 222. The first electrodes 226, 227, 228 may be formed by a metal sheet, in the current embodiment having a thickness of about 2.5 μm, and the output apertures 223, 224, 225 may have a circular shape with a diameter of about 20 μm. The output apertures 223, 224, 225 may have different shapes, such as an elliptical or rectangular shape, depending on the desired beam characteristics.

When operating the cathode ray tube, the first electrodes 226, 227, 228 are connected to a first power supply means V1 (not shown) for applying an electric field having a field strength E1 between the cathodes 205, 206, 207 and the output apertures 223, 224, 225. Generally, the voltage of the first power supply means V1 is in the range of 100-1500 V, for example 1000 V. The field strength E1 and the secondary emission coefficient δ have values that are chosen so as to allow transport of electrons through the electron beam guidance cavity 220, 221, 222, for emission through the output aperture 223, 224, 225 in order to generate an electron beam, as indicated in FIG. 4.

According to the invention, the cathode ray tube further comprises an accelerating grid unit 140, a conventional main lens 150 and a conventional magnetic deflection unit 160 as well as a display screen 170, for example a conventional color phosphor screen, all these parts being known from conventional cathode ray tubes, and the above-mentioned parts being arranged in sequence, with the accelerating grid unit 140 placed in proximity with the output aperture. The above-described cathode ray tube may be applied in, for example, television, projection television or computer monitors.

The accelerating grid unit 140 comprises a first grid G3, being an accelerating grid, and a second and a third grid G4 and G5, respectively, said grids G3, G4, G5 being arranged in sequence with the first grid G3 placed closest to the output aperture 223, 224, 225. Together, said first, second and third grids G3, G4, G5 constitute a low-uni-bi lens. Each grid may comprise one or more plates, each having beam apertures. For a color display, three beam apertures are needed in each plate, one for each of the color beams red, green and blue. The beam apertures may have a plurality of shapes, based on the configuration of the cathode ray tube. However, these beam apertures usually have a circular, quadratic or rectangular shape.

In use, the grids G3 and G5 are connected to a third power supply, providing a voltage V_{g3} and the second grid G4, being placed between said first and third grids, G3 and G5, respectively, is connected to either the potential of said first electrode, that is V1, or a separate voltage Vₛ. Normally, the voltage V_{g3} is within the range of 0.15-0.35 Vₐ, where Vₐ is the voltage applied to the anode in said cathode ray tube, and V_{S} is within the range of 0-V_{g3}.

The above-described embodiment as shown in FIG. 1 and FIG. 2 is advantageous in that no additional electro-optical lens component has to be placed at the output aperture 223, 224, 225 of the electron beam guidance cavity 220, 221, 222, as is the case in the prior art, which uses a cup lens or planar optics.

However, it is also possible to apply the inventive pre-focus accelerating grid unit 140 together with a cup lens or planar optics as functionally described in WO-01/26131. In these cases, the cup lens or the planar optics may be made weaker than would be the case if applied alone, and space charge effects are reduced.

A second embodiment of an electrode structure, for use in a cathode ray tube in accordance with FIG. 1 is shown in FIG. 3. This cathode ray tube comprises first electrodes 326, 327, 328, which are arranged around each output aperture 323, 324, 325, on the outer side of each electron beam guidance cavity 320, 321, 322. The first electrodes 326, 327, 328 may be formed by a metal sheet, in the current embodiment having a thickness of about 2.5 μm, and the output apertures may have a circular shape with a diameter of about 20 μm. The output apertures 323, 324, 325 may have different shapes, such as an elliptical or rectangular shape, depending on the desired beam characteristics.

When operating the cathode ray tube, the first electrodes 326, 327, 328 are connected to a first power supply means V2 for applying an electric field having a field strength E2 between the cathodes 305, 306, 307 and the output apertures 323, 324, 325. Generally, the voltage of the second power supply means V2 is in the range of 100-1500 V, typically 1000 V. The field strength E2 and the secondary emission coefficient δ have values that are chosen so as to allow transport of electrons through the electron beam guidance cavity 320, 321, 322, for emission through the output aperture 323, 324, 325 in order to generate an electron beam.

In accordance with this embodiment of the invention, an electron lens system is formed which comprises the above-described low-uni-bi lens, generated by the accelerating grid unit 140, as well as a cup lens, which is formed by said first electrode 326, 327, 328 and comprises a first and a second part. The first and second parts are positioned behind each other along a symmetry axis of said main lens 150. Said first part preferably has a mean diameter that is smaller than the mean diameter of the second part of the cup lens. In accordance with a preferred embodiment, both parts have a circular symmetry, but an ellipsoidal or rectangular symmetry may be applied in order to obtain an astigmatic cup lens, for further correcting the spot shape on the phosphor screen.

In accordance with a third embodiment of the invention (not shown), an electron lens system is formed, which comprises the above-described low-uni-bi lens, generated by the accelerating grid unit 140, as well as a planar optics electrode unit comprising the first electrode and a second electrode. The second electrode is placed concentric with the first electrode, and said electrodes are preferably arranged in the same plane. Said first and second electrodes may have one of a circular, elliptical or rectangular symmetric shape. By using a combination between a planar optics unit and the above-described low-uni-bi lens, the pulling field directly in front of the funnel may be made larger, since the planar optics unit may be made weaker than in the case with only a planar optics unit.

The inventive construction has the further advantage that the use of a low-uni-bi lens for pre-focusing in the cathode ray tube results in an easily adjustable pre-focus, thereby allowing time-dependent or multimedia applications.

The present invention should not be considered as being limited to the above-described embodiments, but rather includes all possible variations covered by the scope defined by the appended claims.

In this document, the use of a low-uni-bi lens as a pre-focus element in a cathode ray tube is described. The low-uni-bi lens may be used alone or in combination with a cup-lens or planar optics, as described above. However, the invention is not to be considered to be limiting to the above-described combination, but other combinations of a low-uni-bi lens with electro-optical components, having a corresponding effect, may be used.

It should also be noted that for more complicated electron guns, such as guns having Dynamic Astigmatic Focus or Dynamic Beam Forming, the voltages applied to the above-described first and third accelerating grids G3 and G5 may differ from each other. For example, the grids G3 and G5 may be connected to a static and dynamic voltage that differs approximately 0-1.5 kV.

Moreover it should be noted that, even if the above-described embodiments of the invention are described with reference to a low-uni-bi lens, it is also possible to achieve the same effects by using other lens types, such as a high-uni-bi lens.

1. A cathode ray tube (100) comprising:
an electron source (101) having a cathode (105, 106, 107) for emitting electrons,
an electron beam guidance cavity (120, 121, 122) having an input (230, 231, 232) and an output aperture (223, 224, 225) for concentrating electrons emitted from the cathode (105, 106, 107),
a first electrode (226, 227, 228) being connectable to a first power supply means for applying, in operation, an electric field having a first field strength E1 between the cathode (105, 106, 107) and the output aperture (223, 224, 225) so as to allow electron transport through said electron beam guidance cavity (120, 121, 122),
an accelerating grid unit (140) for accelerating the electrons leaving said cavity (120, 121, 122), and
a main electron lens (150) for focusing the accelerated electrons on a display screen (170),
characterized in that said accelerating grid unit (140) comprises a plurality of grids (G3, G4, G5) together constituting a pre-focus lens.

2. A cathode ray tube as claimed in claim 1, wherein said pre-focus lens is a low-uni-bi lens.

3. A cathode ray tube as claimed in claim 2, wherein said low-uni-bi lens comprises a first (G3), a second (G4) and a third (G5) grid, respectively, said first grid (G3) being an accelerating grid, wherein said first (G3) and said third grid (G5) are connectable to a third power supply providing a voltage V_{g3} and said second grid (G4), being placed between said first (G3) and third grids (G5), is connectable to one of the potentials of said first electrode or a separate voltage Vₛ, being within the range of 0-V_{g3}.

4. A cathode ray tube as claimed in claim 1, 2 or 3 wherein said first electrode (226, 227, 228) is positioned in close proximity with said output aperture (223, 224, 225) of the cavity (120, 121, 122).

5. A cathode ray tube as claimed in claim 4, wherein the first electrode (326, 327, 328) comprises a first and a second part being placed behind each other along an axis of said main electron lens (150), wherein a diameter of said first part is smaller than a corresponding diameter of said second part.

6. A cathode ray tube as claimed in claim 4, wherein said cathode ray tube further comprises a second electrode being concentric with said first electrode (226, 227, 228), said second electrode being connectable to a second power supply means for applying a second field strength E2 between said electrodes, wherein the second power supply means is arranged to provide a lower voltage than the first power supply means.

7. A cathode ray tube as claimed in claim 6, wherein said electrodes are positioned in essentially one plane.

8. A cathode ray tube as claimed in claim 1, wherein any of said plurality of grids, together constituting said pre-focus lens, comprises one or more plates being provided with beam apertures.

9. A display apparatus comprising a cathode ray tube as claimed in any one of the preceding claims.
